(19) United States
(12) Patent Application Publication
(10) Pub. No.: US 2007/0257188 A1
(43) Pub. Date: Nov. 8, 2007

(54) Radiometric Calibration

(75) Inventors: Duncan Alexander Robertson, Keltybridge (GB); David Graham Macfarlane, Perthshire (GB); James Christopher George Lesurf, St. Andrews (GB)

Correspondence Address: Christopher P. Harris;Tarolli, Sundheim, Covell & Tummino, 1300 East Ninth Street, Suite 1700, Cleveland, OH, 44114, US

(73) Assignee: Valtion Teknillinen Tutkimuskeskus, Espoo (FI)

(21) Appl. No.: 10/571,654

(22) PCT Filed: Sep. 6, 2004
(86) PCT No.: PCT/GB04/03819

§ 371 Date: Apr. 2, 2007

(30) Foreign Application Priority Data
Sep. 13, 2003 (GB) 0321511.8

(51) Int. Cl. G01D 18/00

(52) U.S. Cl. 250/252.1

(57) ABSTRACT

A calibration load is provided for calibrating a signal in a range of wavelengths or of a single known wavelength. In one embodiment, the load comprises a calibration surface including an emissive material, the calibration surface having relief features, such as pyramids or wedges, that have a dimension that is substantially the same as or less than the shortest wavelength of the range of wavelengths or the single known wavelength that has to be calibrated.

The present invention relates to the calibration of microwave radiometers and in particular radiometric imaging instruments.

### BACKGROUND OF THE INVENTION

It is well known that microwave radiometers, such as Dicke or noise injection or total power radiometers, require regular calibration of their thermal response in order to correct for drift and fluctuations. When radiometers are used in imaging systems, where sensitivity fluctuations can manifest themselves as unwanted stripes or patterns in the image, regular calibration is particularly important to avoid degradation of the image.

Thermal calibration of radiometers can be done in various different ways. For example, in the Dicke radiometer or noise injection radiometer (NIR), the receiver is rapidly switched between the target and a calibration reference. A problem with this, however, is that switching to the calibration reference takes place after the antenna in the signal chain and so any effects of the antenna, or other components before the switch, cannot be calibrated out. In addition, such switched systems have a relatively low sensitivity. Furthermore, at millimetre wave frequencies it is difficult to realise a Dicke radiometer due to the lack of available low-loss switches. In contrast, the total power radiometer (TPR) has better sensitivity. Consequently, the TPR is frequently preferred for high sensitivity radiometer systems and imagers, especially at mm-wave frequencies. With a TPR, calibration is done in front of the antenna and so the entire radiometer can be calibrated. By periodic calibration, excellent stability can be achieved with a TPR, provided the calibration interval is chosen carefully.

Calibration is usually achieved using two reference blackbody loads, which are maintained at different known temperatures. In use with a TPR, the calibration loads are generally viewed in a periodic fashion via a rotating or reciprocating mirror, in between viewing the scene or target of interest. Assuming the emissivities of the loads and their physical temperatures are known, and provided the radiometer is operating in a linear regime, the radiometric response can be calibrated using the well-known Y-factor method.

Conventionally, calibration loads tend to be either at the ambient temperature of the radiometer, heated with an electrical heater, or cooled with a cryogen such as liquid nitrogen. In many cases, to ensure high emissivity, i.e. low reflectivity, the calibration loads are made from corrugated or pyramidal structures and have considerable overall thickness. For ambient loads and those cooled by immersion in a cryogen, absorbing foams are frequently used. However, for heated loads where the heater is often mounted on the rear face or periphery of the load, solid absorbers with adequate thermal conductivities have to be used to ensure an even temperature distribution throughout the material. In some designs, the pyramidal structure is made of metal covered with just a thin coating of absorber to ensure the highest thermal uniformity.

In order to optimise calibration techniques, the characteristics, such as emissivity, of the calibration loads have to be carefully selected. For any object, the radiometrically measured brightness temperature, T_{b}, is equal to the physical temperature, Tₚ, multiplied by the emissivity, ε, i.e.:
T_{b}=ε·Tₚ (1)
The emissivity depends on the material composition and geometry of the object. In general, energy can be absorbed by (A), reflected from (R), and transmitted through (T) an object according to the equation:
A+T+R=1 (2)
For a body in thermodynamic equilibrium, an object's emissivity is equal to its absorption, so:
ε=1−T−R (3)
Therefore, a perfect blackbody with unity emissivity is also a perfect absorber. Because of this, calibration loads are generally made using highly absorbing materials. Transmission through the absorber depends on the inherent absorbing properties of the material used and its thickness. Reflection from the absorber depends on the complex impedance of the material and the geometry of the absorber, particularly the air:material interface.

Theoretically, it is possible to have a lossy material with a complex impedance equal to that of free space so that there is no reflection at the surface. This can be done by balancing the material's dielectric permittivity and magnetic permeability. However, this is not easy to achieve and in practice highly absorbing materials are often quite reflective due to a high refractive index. This means that reflectivity can only be reduced by modifying the geometry of the structure, for example by tapering, to make a graded transition from air into the material. Typically this is achieved by forming the surface of the absorber into tall thin wedges or pyramids. However, loads made of tall thin wedges or pyramids suffer from the practical problem of being difficult to manufacture. Alternatively, in other calibration loads, the material properties are graded from the front to the back in order to minimise the reflected component. By doing this, the need for wedges or pyramids can be avoided and the material can remain flat. However, these materials are often foams loaded with lossy material, and as such are not suitable for use in a calibration load whose temperature is to be controlled by thermal conduction through the load material.

An object of the present invention is to provide an improved calibration load for use in microwave radiometers and an improved technique for calibrating such radiometers.

### SUMMARY OF THE INVENTION

According to one aspect of the present invention, there is provided a calibration load for calibrating a signal in a range of wavelengths or of a single known wavelength, the load comprising a calibration surface including an emissive material, the calibration surface having relief features, such as pyramids or wedges, that have a dimension that is substantially the same as or less than the shortest wavelength of the range of wavelengths or the single known wavelength that has to be calibrated.

Preferably, the load includes means for controlling the temperature, for example a Peltier device. The load may include a heat speader between the heat control means and the emissive material. The heat speader and the emissive material may have co-efficients of thermal expansion that are such as to prevent damage to the emissive material, preferably wherein the co-efficients of thermal expansion are substantially the same. The calibration surface may have dimensions that are at least three times greater than the beam radius in any given measurement plane.

More specifically, the calibration load may take the form of a plate of emissive material whose physical temperature is controlled by mounting it onto one face of a Peltier effect thermoelectric module in such a way that the temperature of the plate is uniform over its area. The plate of emissive material is designed to have at least one straight edge. In use, two calibration loads at different temperatures are arranged in close proximity to each other such that their respective straight edges lie adjacent to one another, forming a sharp thermal step. When used with an imaging radiometer (whether scanned or staring), imaging a step function provides means for measuring the one-dimensional modulation transfer function (MTF) of the imager in the direction perpendicular to the thermal step function. This is a method for characterising the spatial response of the imager.

According to another aspect of the invention, there is provided a calibration load for use in a radiometer comprising a calibration surface including an emissive material carried on a heat spreader material, the emissive material and the heat spreader material having coefficients of thermal expansion that are such as to prevent damage to the emissive material, preferably wherein the coefficients of thermal expansion are substantially the same.

According to yet another aspect of the invention, there is provided a calibration system comprising two or more separate calibration loads, at least one of the loads being operable to act as a hot load and at least one being operable to act as a cold load, the loads being arranged adjacent to each other, thereby to define one or more thermal steps. For example, four calibration loads may be provided. The four calibration loads may be symmetrically arranged, preferably in a cross formation. Preferably, each of the calibration loads has a means for controlling its temperature, such as a Peltier device.

In use, the two or more controllable thermally emissive calibration loads are set to different temperatures and can be used to controllably provide reference radiometric temperatures for calibrating the thermal response of a radiometer. Ideally the temperatures of the calibration loads straddle the range of temperatures of the target that is to be measured with the radiometer.

According to still another aspect of the invention, there is provided a method for calibrating a radiometric imager comprising: capturing radiation emitted from a target area to obtain target area image data and a junction between adjacent hot and cold calibration loads to obtain calibration image data; measuring the temperature of the calibration loads, using the imaged calibration load data and measured temperature date to calibrate the radiometric temperature response, and processing the target area image data using the calibrated temperature. Preferably the imager is a scanning imager and the method further involves scanning across the junction between the hot and cold loads during each sweep of the target area so that calibration is done on a line-by-line basis.

The method may involve using the calibration load image data to detect scanning registration errors for each sweep of the imager and processing the data to correct for these.

The method may involve using the calibration load image data to determine a measure of the modulation transfer function (MTF) of the imager and/or the spatial response of the imager.

According to a still further aspect of the invention, there is provided a passive microwave/millimetre-wave imaging apparatus operating in a close-focussed manner, the apparatus comprising: a detector for sensing millimetre wave electromagnetic radiation; a collector for collecting radiation emitted from a target area that is to be imaged and directing it along a collection path to the detector; a scanner for scanning a line across a target area that is to be imaged to direct target area image data into the collector, and additionally a junction between adjacent hot and cold calibration loads to direct calibration load image data into the collector; means for measuring the temperature of the calibration loads; means for using the imaged calibration load data and measured temperature date to calibrate the temperature, and means for processing the target area image data using the calibrated temperature.

The imaging apparatus may be operable to cause the scanner to scan across the junction between the hot and cold loads during each sweep of the target area so that calibration is done on a line-by-line basis.

In scanned images, it is important that successive scans align well with each other, i.e. are in registration with each other. Due to mechanical backlash or electronic phase shifts in the detection electronics, successive scans may be slightly misaligned. This must be corrected to ensure good image quality. The junction between adjacent hot and cold calibration loads creates a thermal step. Scanning across this thermal step provides a well-defined reference feature against which each line scan can be adjusted to ensure correct registration. To take advantage of this, the imaging apparatus may comprise means for detecting scanning registration errors for each sweep of the imager using the calibration load image data and means for correcting the target image data depending on any detected registration errors.

Means may be provided for determining a measure of the modulation transfer function (MTF) of the imager and/or the spatial response of the imager using the calibration load image data.

Preferably, the imaging apparatus is a passive, non-contacting medical imaging apparatus for imaging subcutaneous body temperature.

According to yet a further aspect of the present invention, there is provided a computer program having code or instructions for using imaged data of a thermal step defined by a hot and a cold calibration load and real measured temperature data of the temperatures of the hot and cold loads to thermally calibrate image data from a target, correct for registration errors and provide corrected image data for the target image.

### BRIEF DESCRIPTION OF THE DRAWINGS

Various aspects of the invention will now be described by way of example only and with reference to the accompanying drawings, of which:

FIG. 1 is a schematic diagram of a microwave imager;

FIG. 2 is a more detailed view of the imager of FIG. 1;

FIG. 3 is a side view of a hot calibration load;

FIG. 4 is a side view of a cold calibration load;

FIG. 5 depicts an infrared thermometer measuring the surface temperature of the calibration load;

FIG. 6 is a plan view of the hot calibration load in FIG. 3;

FIG. 7 is a side view of a pair of calibration loads;

FIG. 8 is a plan view of the pair of calibration loads of FIG. 7;

FIG. 9 illustrates the thermal step function and the measured radiometric response function;

FIG. 10 illustrates the beam pattern;

FIG. 11 illustrates the modulation transfer function (MTF);

FIG. 12 illustrates the spatial calibration method being applied in several planes along the beam to measure the diffraction and depth of focus;

FIG. 13 illustrates a two dimensional array of calibration loads with their thermal profile, alongside the thermal response measured with a radiometer;

FIG. 14 represents an image of a step function which is degraded by mis-registration on successive lines, and

FIG. 15 represents and image of a step function with correct registration.

### DETAILED DESCRIPTION

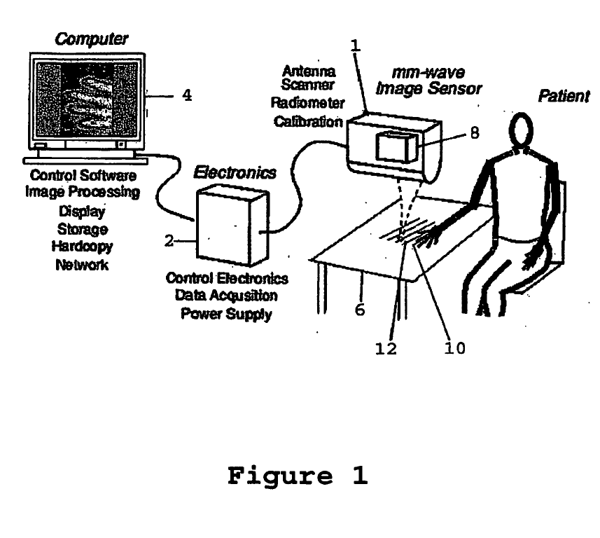

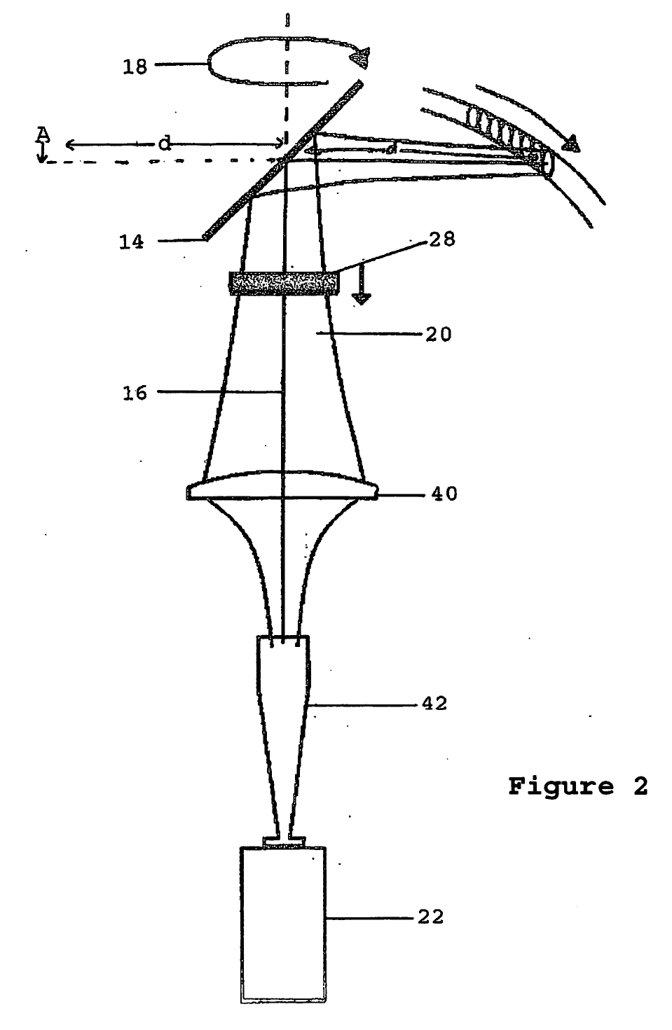

FIG. 1 shows an example of a passive non-contacting imager 1 that is operable to detect millimetre wavelength radiation emitted from the body. By passive it is meant that no radiation is directed onto the patient by the imager. Instead the imager is operable to detect radiation that is naturally emitted from the patient's body. By non-contacting it is meant that the imager does not physically contact the patient. The imager of FIGS. 1 and 2 is ideally operable to form an image from emitted radiation in the frequency range of 10-200 GHz, and preferably in the range 90-100 GHz. This imager is the subject of a co-pending International patent application PCT/GB2003/001284, the contents of which are expressly incorporated herein by reference.

The imager of FIG. 1 is connected to electronic circuitry 2 for controlling and supplying electrical power thereto and also receiving image data therefrom. Received data is processed and displayed as an image on a computer 4. The imager 1 is positioned a few tens of centimetres directly above a tabletop 6 on which a part of the patient to be imaged is rested, in this case the hand. The components of the imager 1 are contained within a housing 8 that has a lower window (not shown) through which an area of the tabletop 6 can be scanned, in order to obtain the image. The apparatus scans the area in a succession of parallel lines, such as lines 10 and 12.

FIG. 2 shows the imager 1 of FIG. 1 in more detail. This comprises a planar mirror 14 that is rotatably mounted about an axis 16. Optionally, the mirror 14 may be rotatable about two separate axes (not shown). Connected to the mirror 14 is a motor (not shown), which is operable to rotate the mirror in the direction indicated by the arrow 18. The mirror 14 is in registry with the window in the housing 8 and is provided to scan an area of the patient and direct millimetre radiation received from that area into a main optical path 20 and towards a detector 22. As an example, the radiometer may be a 95 GHz heterodyne total power radiometer 22.

On the optical path between the mirror 14 and the detector 22 is an isolation means, for example, a quasi-optical isolator 28. This is provided to prevent signals leaking out from the apparatus. Certain types of radiometer, especially heterodyne designs, can leak local oscillator (LO) signals out of the input port of the mixer of the radiometer. This can be coupled out via the antenna towards the subject/target, which can degrade the performance of the radiometer by causing fluctuations in its sensitivity. This can be misinterpreted as radiation emitted by the target. Providing an isolator 28 avoids this effect.

Radiation transmitted through the isolator 28 is directed into focussing means, for example a high-density polyethylene lens 40 and from there, into a feedhorn, in particular a corrugated feedhorn 42, as shown in FIG. 2. The lens 40 is adapted to focus on a spot on a cylindrical object plane for a given position of the mirror 14 and direct radiation emitted from that spot to the feedhorn 42. Radiation focussed by the lens 40 on the feedhorn 42 takes the form of a substantially fundamental Gaussian mode beam. This has a well-defined profile across and along substantially the entire collection path between the focussing means and the feedhorn 42. The corrugated feedhorn collects this radiation and converts it into a waveguide mode. The received radiation is fed to the detector 22 and used to image the scanned area of the patient's body.

As mentioned above, the sensitivity profile of the radiation collected in the scanner of FIG. 2 is well-defined. More specifically, the sensitivity profile of the radiation collected is a Guassian profile. It should be noted that the feedhorn 42 and/or lens 40 of FIG. 2 can be considered to act as an antenna. As a result of the reciprocal nature of antennas, the sensitivity profile corresponds to the antenna beam pattern. This means that were the detector to be replaced with a signal source or emitter, the apparatus would emit along the collection path a beam having a fundamental mode Gaussian intensity profile.

In the apparatus of FIGS. 1 and 2, scanning of a target area of a patient's body is effected by rotating the mirror 14. This provides a single line scan. To collect data over a wider area, the housing 8 is mounted on a support (not shown) that facilitates controlled indexing movement of the housing 8 along a direction perpendicular to the scanning direction, indicated by line III of FIG. 1. Indexing occurs at most once for every revolution of the mirror 14. In order to reduce the effects of noise, the system can be arranged to average the results of a number of successive scans along each line. In this case, the mirror undergoes a number of revolutions, for example five, at any given axial position before indexing occurs. This improves the signal to noise ratio of the device. However, it will be appreciated that this would be done at the expense of the speed of image acquisition.

In order to calibrate the imager of FIGS. 1 and 2, hot and cold calibration loads 44 and 46 respectively are placed in the collector beam path and positioned close to each other so as to define a sharp thermal step. Because the calibration loads 44 and 46 lie in the beam collection path, calibration data can be collected on a line-by-line basis.

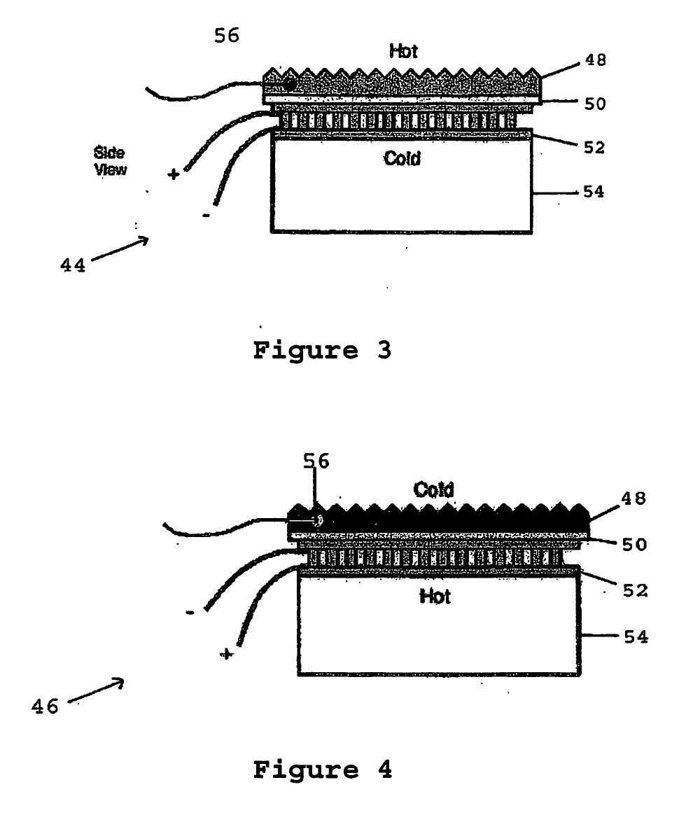

FIG. 3 is a side view of the hot calibration load. This has emissive material 48 that is attached to a heat spreader plate 50, for example using thermally conductive adhesive, the heat spreader plate 50 being mounted on a Peltier device 52. The heat spreader plate 50 is designed to even out any minor non-uniformities in the temperature distribution over the upper surface of the Peltier device 52. The heat spreader plate 50 is made of a material that has a good thermal conductivity such as aluminium or copper. The Peltier device 52 pumps heat from one face to the other depending on the polarity and magnitude of the current passed through it. The face of the Peltier device 52 that is opposite the heat spreader plate 50 is attached to a heatsink 54. In the case of the hot calibration load 44, heat is pumped out of the heatsink 54 and into the heat spreader plate 50 and emissive material 48.

FIG. 4 is a side view of the cold calibration load 46. This is identical to the hot calibration load 44 except that the direction of current in the Peltier 52 is reversed. Heat is now pumped out of the emissive material 48 and heat spreader plate 50 and dumped into the heatsink 54.

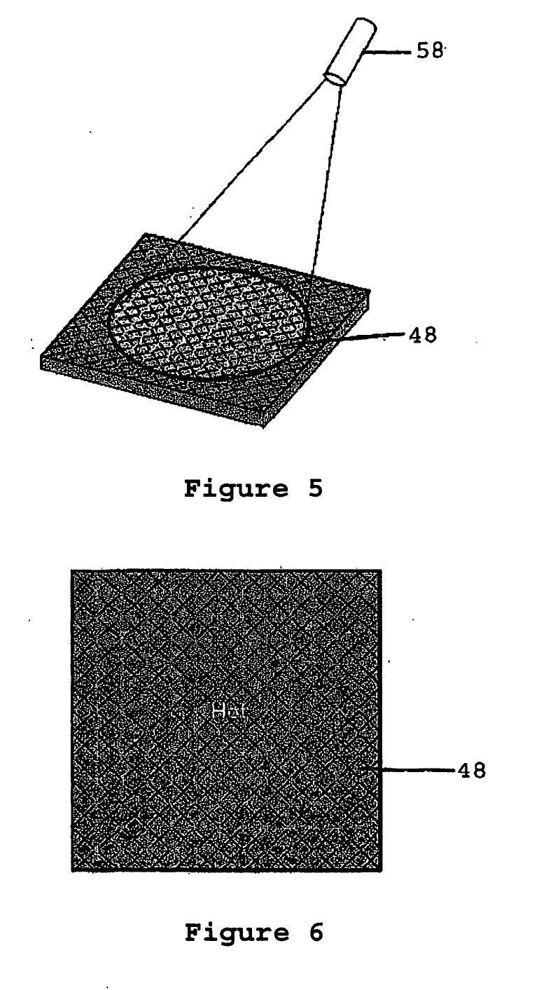

The physical temperature of the emissive material 48 can be monitored with a thermometer 56 (e.g. a thermocouple or resistance temperature detector (RTD)), preferably embedded within the material, or attached to its upper surface as shown in FIGS. 3 and 4. Alternatively, the temperature of the emissive material 48 can be monitored using a non-contacting infrared thermometer 58, which is pointed at the surface of the calibration load from above as shown in FIG. 5. Provided the emissivity of the material at infrared wavelengths is known, the infrared thermometer 58 will give an accurate measurement of the physical temperature of the surface of the load.

The choice of emissive material 48 and geometry of the emissive plate are governed by several factors that are principally driven by the requirements needed to characterise the imaging response of the instrument. In order to provide a well-defined thermal step function which lies in a specific plane, the emissive layer must be relatively thin and planar or quasi-planar in structure. This is in contrast to the designs of calibration loads described in the prior art. This particular feature is the primary driver behind the selection of the emissive material 48.

The emissive material 48 must have a reasonable thermal conductivity so that its physical temperature can be controlled by the Peltier 52 from the back face, and so that the plate of emissive material 48 achieves a uniform temperature, right to the edges. As shown in FIG. 6, the emissive material 48 and heat spreader plate 50 are the same size as the Peltier device to ensure uniform temperature distribution is maintained across the area of the plate. Examples of material that could be used include solid absorbers of the iron-loaded epoxy type. These typically have a thermal conductivity of about 1 Wm⁻¹K⁻¹, which is adequate but obviously much less than that of metal (e.g. 237 Wm⁻¹K⁻¹ for aluminium).

The emissive material 48 should also have a coefficient of linear thermal expansion, which is not too dissimilar to that of the metal plate to which it is attached. If the coefficients are not matched then as the load temperature changes the absorber can break off the metal plate due to differential expansion or contraction. Iron-loaded epoxy absorbers have an expansion coefficient of about 30×10⁻⁶ K⁻¹, which is quite close to that of aluminium at 23.5×10⁻⁶ K⁻¹, and so could be used as the emissive material, when the heat speader plate 50 is made of aluminium or any other material having a similar co-efficient of linear expansion. The emissive material 48 should also be such that it remains physically stable over the range of temperatures used for the calibration loads. In particular, it should have a high upper working temperature so that the material does not soften, melt or decompose at the temperature of the hot calibration load.

In order to minimise thermal gradients from the back face to the front face, the emissive material ideally should be relatively thin. This implies that in order to be an effective absorber, the specific attenuation of the material must be high. This can be achieved using solid absorbers having a high loading of absorbing constituents. To achieve a load with a high emissivity it is desirable that the one-way transmission through the material is at least −20 to −30 dB. In addition, it is desirable that the load has a low reflectivity, e.g. a return loss of better than about −20 dB. For example, if the transmission T and reflectivity R are both −20 dB (i.e. 0.01) then the emissivity is 0.98. Unfortunately, materials with high specific attenuations also tend to have high refractive indices and hence are not inherently low reflectivity. Consequently, the surface has to be modified to make a gradual taper into the material from air. This can be done by forming wedges or pyramids on the surface. Parallel wedges function well for linearly polarised radiometers where the polarisation is aligned perpendicular to the wedges. Pyramids are more suitable for use with arbitrary polarisation.

In terms of minimising the reflectivity, tall narrow wedges or pyramids are desirable and have been used in conventional calibration loads successfully. However, features like this having a high aspect ratio contradict the requirement that the absorber be thin and quasi-planar in order to exist in a well-defined plane. Whilst conventional loads use wedges or pyramids several wavelengths deep, it is a feature of this invention that the relief features 60, typically wedges or pyramids, should be shallow, i.e. have a depth, comparable with or less than the wavelength of the radiation that is to be detected, in order to meet the requirements outlined above. Consequently, in a close-focussed, diffraction limited imaging system, the loads will appear to exist in a well-defined plane. The lateral size of the loads 44 and 46 is also important, and it should be ensured that they are bigger than the size of the radiometer beam. For example, with a Gaussian profiled beam as might be used in a close-focussed imaging system, such as that shown in FIG. 1, it would be appropriate to make the width and length of the loads at least 3 or 4 times greater than the beam radius in any given measurement plane (the beam radius being defined as the 1/e² radius in power).

As a specific example, a calibration load suitable for use at an operating wavelength of 3.2 mm was made from a two-part epoxy loaded with small carbonyl iron spheres, in particular the material used was Ferroflow from Microwave Filter Company, East Syracuse, N.Y., USA. This was cast in a mould to give a calibration load in the form of a plate with one flat face and the other face covered in parallel V-grooves. The area of each plate was 62×62 mm. The pitch of the V-grooves was 2.0 mm and their depth was 2.0 mm. The depth of material between the bottoms of the grooves and the flat (back) side was also 2.0 mm. Thus the maximum thickness from the back of the plate to the tips of the Vs was 4.0 mm. Since the wavelength of the radiation to be detected in this case was 3.2 mm (94 GHz), this meant that the relief features defined by the V-grooves on the surface of the load had dimensions smaller than that of the wavelength. In use, the V-grooves were used perpendicular to the polarisation of the radiometer. For each load, the measured reflectivity (R) was 0.03 and the transmission (T) was 0.003. The emissivity, ε, can be calculated from equation (3) which gives ε=0.967. This was considered adequately close to 1.0 to consider the load as a black body. Hence a calibration load of this nature is ideal for thermally calibrating radiometric imagers, such as that shown in FIGS. 1 and 2.

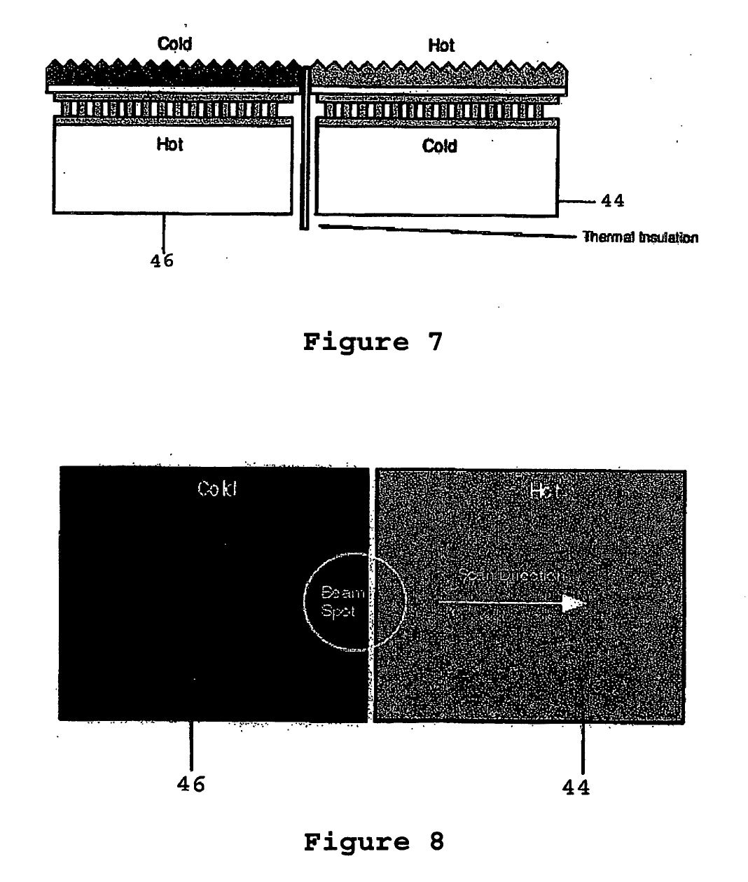

The calibration loads of FIGS. 3 and 4 can be used to thermally calibrate imagers, such as that of FIGS. 1 and 2. To do this, the hot and cold loads are placed adjacent one another, as shown in FIG. 7, so that a thermal step function is defined. This arrangement can also be used to provide a measure of the spatial resolution and allow registration errors to be corrected.

In use, the pair of loads of FIG. 7 would be placed in the scanning path of the imager, such as at position A in FIG. 2. The loads should be arranged so that the thermal step is perpendicular to the direction of scanning and the surfaces of the loads are substantially perpendicular to the beam itself. Also, the loads should be located at the focal point of the radiometer, so that the optical path for radiation emitted from the loads is substantially the same as for radiation emitted from the target area. It should be noted that in practice, the pair of loads would be moved with the scanner as it progresses or is indexed from line to line so each line scan sees the same thermal step. Without arranging it this way, the loads would have to be as long as the full length of the image, which in most cases would be impractical. When the adjacent loads of FIG. 7 are included in the imager, the thermal step can be viewed by the radiometer beam as it scans across the loads, as shown in FIG. 8.

Whilst the loads are referred to as hot and cold, it will be appreciated that these terms are relative to the expected temperature range of the target that is to be imaged. In practice the cold load should be at a temperature that is less than that of the target area and the hot load should be at a temperature that is more than that of the target load. For the purposes of measuring subcutaneous body temperatures, the difference in temperature between the calibration loads should be at least about 40 C, and preferably more. For example, the cold load could be set at, say, 10 C and the hot load could be set at 60 C.

Ideally the gap between the loads should be as small as possible in order that the thermal step is as sharp as possible. However, this has to be balanced against any degradation in heat uniformity caused by heat leaking from the hot load to the cold load. A thin sheet of thermal insulation may be inserted between the loads to improve thermal isolation. Alternatively, the region between the two loads may simply be an air gap. A fan may be used to dissipate waste heat from the heatsinks, particularly that of the cold load whose heatsink will be warm and could heat up the cold load by convection if the waste heat is not removed efficiently.

Care needs to be taken with the cold load to prevent condensation forming on the surface, which would modify the emissivity and therefore affect the calibration. Condensation occurs when warm humid air is cooled to the dew point or below. The dew point is dependent on the ambient temperature and the humidity of the air. Condensation can be avoided by ensuring that the cold load never reaches the dew point in normal operating conditions, although this limits the choice of cold calibration temperature. For example, with air at 25° C. and a relative humidity of 50%, the dew point is 13.8° C. but a lower cold calibration temperature than this may be desirable. Alternatively, the calibration loads could be enclosed in a box that is transparent to the radiation of interest, which contains a desiccator to keep the air dry. For example, for a microwave/millimetre wave imager the box could be made of Styrofoam, which is transparent to microwaves and millimetre waves and so the radiometer can just look straight through it to the calibration loads. Doing this would allow the cold calibration load to be maintained at a much lower temperature than in ambient humid air, and hence at a much greater temperature difference from the hot load. This improves the calibration accuracy.

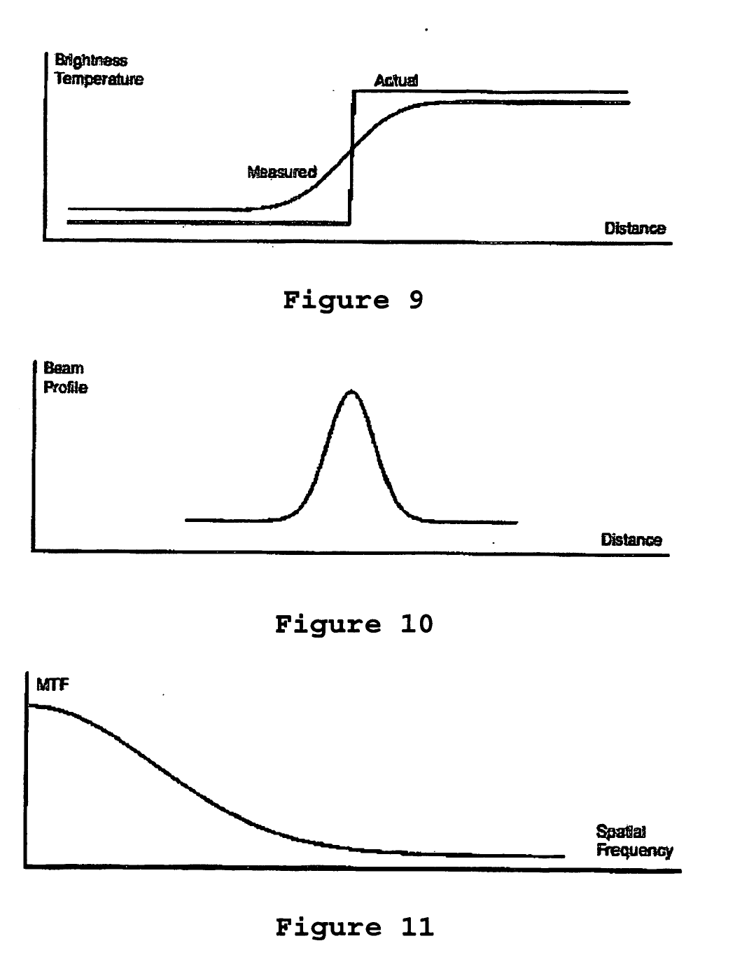

As well as providing a means for thermally calibrating an image beam, the thermal step function defined by the hot and cold loads of FIG. 7 can be used to calibrate the spatial resolution of the imager. This can be done by determining the modulation transfer function of the instrument by scanning the beam across the thermal step function. It should be noted that the junction between the hot and cold loads should be arranged perpendicular to the direction of scanning as shown in FIG. 8. Whilst the actual thermal step function is a sharp discontinuity, the radiometer's measured response is modified by the shape of the antenna pattern at the particular plane in which the measurement is being made, as shown in FIG. 9. Strictly, the radiometer's step response function is the convolution of the antenna pattern with the thermal step function. Taking the derivative of the measured step response yields the beam profile or antenna pattern at the measurement plane, as shown in FIG. 10.

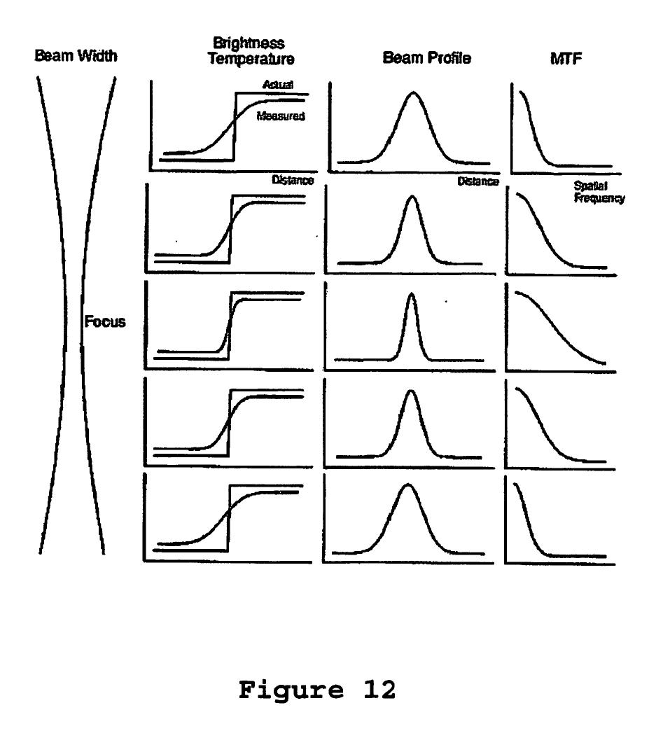

To determine the MTF, the magnitude of the Fourier transform of the beam profile is used. This is shown in FIG. 11. The MTF represents the instrument's response versus spatial frequency and is used to indicate the spatial resolution of the imager. In a close-focussed imaging system in which the beam is diffracting strongly with distance, such as described with reference to FIG. 1, it is beneficial to measure the MTF in different planes along the beam. This is shown in FIG. 12. To do this, the calibration loads that define the thermal step are moved to different positions along the length of the beam. Measuring the MTF as a function of distance along the imager beam enables the focal plane to be determined accurately, and also measures the depth of focus of the instrument. This sort of measurement would probably only be performed occasionally, or even only once when the instrument is built. However, the data gathered should be stored as a record of exactly how the instrument's spatial response varies with the distance down beam, and therefore over what range of distances the imager will be in focus.

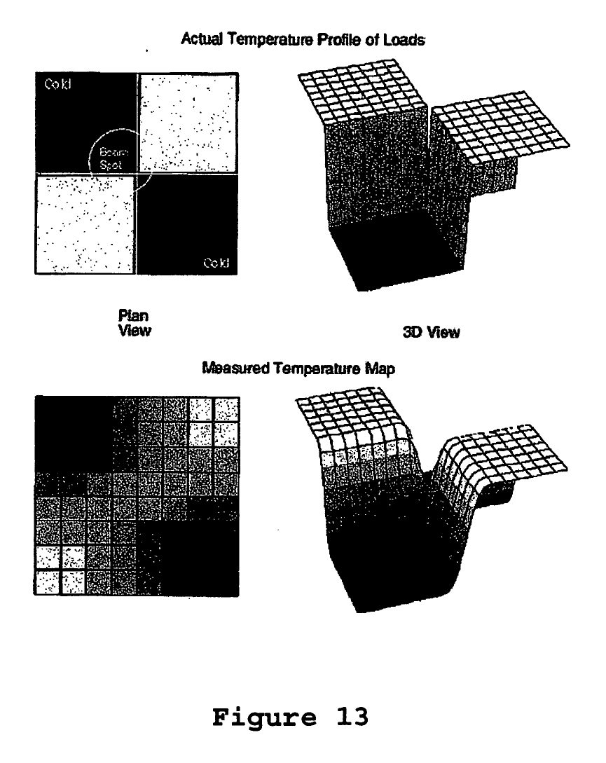

Measurement of the MTF using the thermal step is applicable to scanning imagers and staring array imagers. The principle can also be extended to two dimensions (2D). In this case, multiple calibration loads would be arranged in close proximity to make a thermal “test card” with which to calibrate the spatial response in both dimensions. For example, FIG. 13 shows four calibration loads positioned in an array, thereby providing thermal step functions in two orthogonal directions. The 2D response function as measured by the radiometer is also shown. When the antenna pattern of the radiometer is well known it can be deconvolved from the measured response function thus improving the spatial resolution of the imager.

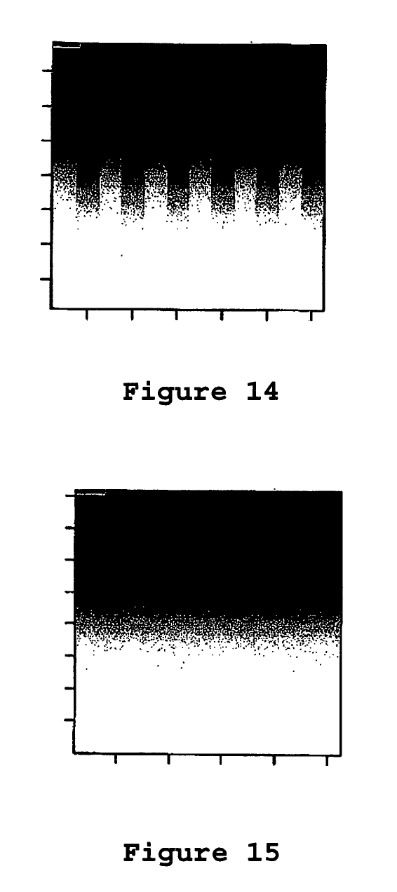

To further improve the performance of the imager, registration of the scanned image lines is calibrated. This can also be done using the thermal step defined by the calibration loads of FIG. 7. To do this successive lines are scanned across the thermal step function, again ensuring that the step function is aligned perpendicular to the direction of scanning. Any offset from line to line, or registration error, in the image can be immediately identified as a shift in the apparent position of the step function. FIG. 14 shows an image of a step function in which alternate lines are offset by a constant amount. This problem can be particularly apparent in imagers, which reciprocate, scanning successive lines in opposite directions. Any mechanical backlash in the scanning motion could cause registration errors. Additionally, if the radiometric signal is low-pass filtered, as is generally the case with TPRs, the filtering process can introduce a phase or time delay, which manifests itself as line-by-line registration errors. By measuring the offset in the position of the step response the registration can be corrected and a correct image obtained. FIG. 15 shows an image of a step function in which all the lines are in registry.

To measure the registration offset the radiometric signal is oversampled in the scan direction. Conventionally, imagers record the fewest numbers of pixels that is considered necessary to preserve the information content in the scene. This might be every half beamwidth or every beamwidth/SQRT(2) depending on the system design. The well-known sampling theorem states that to capture a complete record of a signal sampling has to be done at a rate that is at least twice the frequency of the highest frequency component contained in the signal. Sampling any higher than this is called oversampling. The problem arises when, as is the case with many real signals, the information content in the signal does not abruptly die off to zero at some well defined frequency. Instead it decays away gradually. Then a compromise decision has to be taken as to what is the highest frequency containing measurable, useful information in the signal. By oversampling at a selected rate, even small offsets, for example sub-beamwidth offsets, can be corrected. This may result in an excess of data, but this can be filtered and thinned afterwards. It should be noted that in practice, the offset may only be a fraction of a pixel but if the data is not oversampled, shifting the scan by one whole pixel could actually make the registration worse. Techniques for controlling the sampling rate of imagers are well-known and so will not be described herein in detail.

In practice, the scanner of FIGS. 1 and 2 can be calibrated on a line-by-line basis to take into account the thermal conditions and also any registration errors. This is done by measuring using the imager the thermal step defined between the two hot and cold calibration loads of FIG. 7, and recording the temperature that is measured by the thermometers. The raw data from the imager is provided by the control electronics to the control computer 4 for use by image-processing software. Likewise, the temperature of the calibration loads 44 and 46 is measured using the thermometer 56 or 58 and this measured temperature is passed to the control computer. The radiometrically imaged data and physically measured temperature data are then processed using the image-processing software to provide a final image.

To obtain an image using the imager of FIGS. 1 and 2, a line scan is firstly performed by scanning the radiometer over the target area and the hot and cold calibration loads yielding raw uncalibrated voltage data, and recording the physical temperatures of the hot and cold calibration loads. This data is provided to the control computer. Once this is done the radiometer output is calibrated using the image-processing software based on the load temperatures using the Y-factor method to give the slope and offset of radiometer's voltage:temperature linear response function. The Y-factor method is well known in the art and so will not be described herein. Then, the line scan data is scaled according to the calibration so that the line data reads correctly in true temperature. The hot:cold thermal step response in data is then compared to the previous line scan and, if necessary, its position is corrected for registration errors. In this regard, the first line of the image is used as the reference. Then the 1D beam pattern is derived by taking the differential of the thermal step response, and possibly fitting a curve to the data—e.g. a Gaussian. When this is done, the 1D MTF is then derived by taking the magnitude of the Fourier transform of the beam pattern or the fitted beam pattern curve if the real data are too noisy. The MTF curve is then compared with pre-determined data to determine whether it is within expected limits and so to confirm correct operation. Then, the scanner is indexed in another coordinate to move to new line, and the scanning procedure is repeated until all line scans are finished, so as to provide a complete, thermally calibrated and correctly registered image. If desired, at this stage the image data may be deconvolved with a 2D beam pattern to yield the corrected source image.

It should be noted that measuring the MTF need not require any action to be taken on the image data on a line-by-line basis—it could simply be a check that the instrument response is consistent over time. Deconvolving the beam pattern from the image can only be done using a 2D beam pattern, which cannot be obtained from a 1D scan of a thermal step function. The 2D beam pattern could be obtained from two orthogonal step functions (as per FIG. 13) but this would require a calibration system that remains static as the beam is scanned over it, and so this could only be performed once per image rather than once per line. The beam pattern would not be expected to change with time particularly, but it might, so deconvolving with a regularly measured 2D beam pattern may be desirable in some circumstances.

The present invention provides a method of calibration that may be used with radiometric imagers, particularly those that are scanned and operate in a close-focussed fashion. The method involves combining thermal calibration with spatial calibration and correction for line-by-line registration errors. This can be done by measuring a thermal step that is provided by two adjacent thermally controllable calibration loads, one hot and one cold. By providing line-by-line calibration of this nature, the sensitivity and response of the imager is greatly enhanced.

A skilled person will appreciate that variations of the disclosed arrangements are possible without departing from the invention. For example, whilst the calibration loads and techniques are described primarily with reference to the imager of FIGS. 1 and 2, it will be appreciated that these could be used with any scanning radiometric imager that operates in a closed-focussed manner. Accordingly the above description of the specific embodiment is made by way of example only and not for the purposes of limitation. It will be clear to the skilled person that minor modifications may be made without significant changes to the operation described.

1. A calibration load for calibrating a signal in a range of wavelengths or of a single known wavelength, the load comprising a calibration surface including an emissive material, the calibration surface having relief features, such as pyramids or wedges, that have a dimension that is substantially the same as or less than the shortest wavelength of the range of wavelengths or the single known wavelength that has to be calibrated.

2. A load as claimed in claim 1 comprising means for controlling the temperature of the load, preferably a Peltier device.

3. A load as claimed in claim 2 comprising a heat speader between the heat control means and the emissive material.

4. A load as claimed in claim 3, wherein the heat speader and the emissive material have coefficients of thermal expansion that are substantially the same.

5. A load as claimed in claim 1 wherein the calibration surface has dimensions that are at least three times greater than the beam radius of the signal that is to be calibrated in any given measurement plane.

6. A calibration system comprising two or more separate calibration loads, at least one of the loads being operable to act as a hot load and at least one being operable to act as a cold load, the loads being arranged adjacent to each other, thereby to define one or more thermal steps.

7. A calibration system as claimed in claim 6 wherein four calibration loads are provided.

8. A system as claimed in claim 7 wherein the four calibration loads are symmetrically arranged in a cross formation.

9. A system as claimed in claim 6 comprising one or more of calibration loads, a given calibration load comprising a calibration surface including an emissive material, the calibration surface having relief features, such as pyramids or wedges, that have a dimension that is substantially the same as or less than the shortest wavelength of the range of wavelengths or the single known wavelength that has to be calibrated.

10. A method for calibrating a radiometric imager comprising:
capturing radiation emitted from a target area to obtain target area image data and capturing radiation emitted from a junction between adjacent hot and cold calibration loads to obtain calibration image data;
measuring the temperature of the calibration loads using a thermal sensor;
using the imaged calibration load data and measured temperature data to calibrate the radiometric temperature response, and
processing the target area image data using the calibrated temperature.

11. A method as claimed in claim 10 comprising scanning the target area and the junction between the hot and cold loads during each sweep, so that calibration is done on a line-by-line basis.

12. A method as claimed in claim 10 comprising using the calibration load image data to detect scanning registration errors for each sweep of the imager and processing the data to correct for these.

13. A method as claimed in claim 10 comprising using the calibration load image data to determine a measure of the modulation transfer function (MTF) of the imager and/or the spatial response of the imager.

14. A passive microwave/millimetre-wave imaging apparatus operating in a close-focussed manner, the apparatus comprising:
a detector for sensing millimetre wave electromagnetic radiation;
a collector for collecting radiation emitted from a target area that is to be imaged and directing it along a collection path to the detector;
a scanner for scanning a line across a target area that is to be imaged to direct target area image data into the collector, and additionally a junction between adjacent hot and cold calibration loads to direct calibration load image data into the collector;
means for measuring the temperature of the calibration loads;
means for using the imaged calibration load data and measured temperature date to calibrate the temperature, and
means for processing the target area image data using the calibrated temperature.

15. An imaging apparatus as claimed in claim 14 that is adapted to scan across the junction between the hot and cold loads during each sweep of the target area so that calibration is done on a line-by-line basis.

16. An imaging apparatus as claimed in claim 14 that is adapted to use the calibration image data to detect scanning registration errors for each sweep of the imager and correct for these.

17. An imaging apparatus as claimed in claim 14 that is adapted to use the calibration load image data to determine a measure of the modulation transfer function (MTF) of the imager and/or the spatial response of the imager.

18. An imaging apparatus as claimed in claim 14 that is a passive medical imaging apparatus for imaging subcutaneous body temperature.

19. An imaging apparatus as claimed in claim 14 wherein each of the hot and cold calibration loads comprising a calibration surface including an emissive material, the calibration surface having relief features, such as pyramids or wedges, that have a dimension that is substantially the same as or less than the shortest wavelength of the range of wavelengths or the single known wavelength that has to be calibrated.

20. An image processing computer program having code or instructions for using imaged data of a thermal step defined by a hot and a cold calibration load and real measured temperature data of the temperatures of the hot and cold loads to thermally calibrate image data from a target, and correct for registration errors.

21. An image processing computer program having code or instructions for processing the imaged data of the thermal step to obtain a measure of the modulation transfer function (MTF) of the imager and/or the spatial response of the imager.
